(19) United States
(12) Patent Application Publication
(10) Pub. No.: US 2020/0234275 A1
(43) Pub. Date: Jul. 23, 2020

(54) User Interface Display Method And Terminal Device

(71) Applicant: HUAWEI TECHNOLOGIES CO., LTD., Shenzhen (CN)

(72) Inventors: Peng ZHANG, Beijing (CN); Chenguang LIU, Beijing (CN)

(21) Appl. No.: 16/843,630

(22) Filed: Apr. 8, 2020

Related U.S. Application Data
(63) Continuation of application No. PCT/CN2019/087338, filed on May 17, 2019.

(30) Foreign Application Priority Data
Jun. 20, 2018 (CN) 201810637260.8

(51) Int. Cl. G06Q 20/32; G06Q 20/40; G06Q 20/38; G06F 21/53; G06F 9/451

(52) U.S. Cl. CPC G06Q 20/3227; G06Q 20/405; G06F 9/451; G06Q 20/3223; G06F 21/53; G06Q 20/382

(57) ABSTRACT

A solution for compatibility between TUI display and Android display is provided. Based on a native control provided by a rich operating system, a customized secure control is further added, thereby simplifying TUI development. Further, the rich operating system performs drawing processing on a native control in a user interface, synchronizes a non-secure surface obtained after processing to a frame buffer of a trusted operating system on a TEE side, and transfers identified information about a secure control in the user interface to the trusted operating system on the TEE side. The trusted operating system processes drawing processing on the secure control based on the information about the secure control and a customization method corresponding to the secure control, composites a secure surface and the non-secure surface that are obtained after processing, and then displays a composited surface by using a display.

### CROSS-REFERENCE TO RELATED APPLICATIONS

This application is a continuation of International Application No. PCT/CN2019/087338, filed on May 17, 2019, which claims priority to Chinese Patent Application No. 201810637260.8, filed on Jun. 20, 2018. The disclosures of the aforementioned applications are hereby incorporated by reference in their entireties.

### TECHNICAL FIELD

This application relates to the terminal field, and more specifically, to a trusted user interface display method and a terminal device.

### BACKGROUND

With promotion and popularization of intelligent terminals, mobile payment has become one of main payment manners of people's daily consumption. The mobile payment is a service manner in which a user pays for a consumed commodity or service by using a mobile terminal (usually a mobile phone). While the mobile payment brings convenience to the user, security of the mobile payment has always been a concern. A mobile payment application usually runs in an open rich execution environment (REE). The REE is also referred to as a general operating environment, and mainly includes a rich operating system (Rich OS) running on a general purpose processor, for example, a terminal operating system such as Android® or iOS®. Such an open environment provides a channel for information leakage and malware transmission, and therefore it is difficult to satisfy a requirement of the mobile payment for security. For example, in the REE, a payment amount or an entered password displayed by an application may be hijacked by a malicious application, resulting in various payment security problems.

To resolve this problem, the Open Mobile Terminal Organization (OMTP) proposed a concept of a trusted execution environment (TEE). In July 2010, the GlobalPlatform® (GP) proposed a TEE standard. The TEE is an independent operating environment that runs outside the REE and is isolated from the REE. All applications in the TEE are dedicatedly customized trusted applications (TA). The TA may access hardware and software resources of the TEE by using an internal interface of the TEE. An application in the REE, also referred to as a client application (CA), cannot directly access the hardware and software resources of the TEE. The CA in the REE, only after TEE identity authentication succeeds, can invoke a resource or a service of the TEE, such as secure storage or secure display/input, by using an application programming interface (API) provided by the TEE. In this way, in a mobile payment scenario, if sensitive information input and display are needed, the CA on the REE side may invoke a secure display/input TA in the TEE, to display a trusted user interface (TUI) that satisfies a GP specification, so that a user enters sensitive information of the user, for example, enters a personal identification number (PIN) and confirm transaction information, by using the TUI. After the TUI is displayed, an entire screen display area is taken over by the TEE, and access of the REE to the display area is completely blocked, thereby preventing the CA in the REE from maliciously intercepting and stealing the sensitive information of the user.

FIG. 1 shows an example in which a user performs a transfer operation by using a TUI. As shown in FIG. 1, the user logs in to a mobile phone banking application on an REE side and enters information such as a transfer amount in a transfer interface. Then, when the user enters and verifies a PIN code, the application invokes a secure display/input TA on a TEE side by using a specific interface to display the TUI. After the user enters the PIN code and confirms transaction information by using the TUI, a screen display area is returned to the REE. The mobile phone banking application on the REE side then displays a transfer complete page, and an entire transaction process ends. It can be learned from FIG. 1 that, UI display of the CA on the REE side and TUI display on the TEE side are two independent processes. The TUI and a CA interface are not closely related and are not inconsistent in terms of styles. Moreover, the TUI is displayed in full screen and covers the entire screen display area. Therefore, a TUI control cannot be compatible with a control in the CA interface for display. For example, when the TUI is displayed, the user cannot see a status bar, a navigation bar, or the like, affecting user experience.

### SUMMARY

This application provides a user interface display method and a terminal device, to implement compatible display of a trusted user interface (TUI) control and a client application (CA) interface control, and improve user experience.

According to a first aspect, an embodiment of this application provides a user interface display method, which may be applied to a terminal device that includes a trusted execution environment (TEE) and a rich execution environment (REE), or another similar device. A rich operating system and a client application run in the REE. A trusted operating system runs in the TEE. A user interface of the application includes a common control (non-secure control) and a secure control. The method includes: rendering, by the rich operating system, the common control in the user interface to obtain a first surface; rendering, by the trusted operating system, the secure control in the user interface to obtain a second surface; and compositing, by the trusted operating system, the first surface and the second surface to obtain a composited surface that includes graphical representations of both the secure control and a native control, and displaying the composited surface by using a display, thereby implementing compatible display of the secure control and the non-secure control. In this way, at the same time when a secure input interface is displayed, a common interface control can also be displayed, thereby improving user experience.

In a possible implementation, the rich operating system performs measurement, layout, and drawing operations on the common control by using a graphics-related service or component, to complete rendering of the common control, and buffers, to a frame buffer of the rich operating system, a non-secure surface obtained after rendering the common control.

In a possible implementation, the rich operating system transfers information about the secure control to the trusted operating system by using a communications agent.

In a possible implementation, the communications agent of the rich operating system transfers the information about the secure control to the trusted operating system by using a client interface (Client API) provided by the TEE.

In a possible implementation, the trusted operating system performs measurement and layout operations on the secure control based on the information about the secure control, to determine a size and a display position of the secure control; and draws the secure control based on the determined size and display position of the secure control, to obtain the second surface, where the second surface is in a frame buffer of the trusted operating system.

In a possible implementation, the rich operating system sends the first surface in the frame buffer to the trusted operating system by using the communications agent. The trusted operating system composites the first surface and the second surface after obtaining the first surface, to obtain the composited surface, where the composited surface is in the frame buffer of the trusted operating system.

In a possible implementation, the rich operating system sends an address of the frame buffer of the rich operating system to the trusted operating system by using the communications agent. After obtaining the address, the trusted operating system accesses the first surface in the frame buffer of the rich operating system based on the address, and composites the first surface and the second surface to obtain the composited surface, where the composited surface is in the frame buffer of the trusted operating system.

In a possible implementation, the trusted operating system may access the frame buffer of the rich operating system. The frame buffer of the trusted operating system cannot be accessed by the rich operating system.

In a possible implementation, there are a plurality of frame buffers of the rich operating system and/or the trusted operating system.

In a possible implementation, after rendering the common control, the rich operating system obtains a plurality of surfaces, where each surface is in a separate frame buffer. The rich operating system offline combines the plurality of surfaces into the first surface by invoking graphics-related hardware. Then the trusted operating system composites the first surface and the second surface.

In a possible implementation, the compositing the first surface and the second surface includes: performing parameter calculation based on a parameter of each pixel included in the first surface and a parameter of each pixel included in the second surface, to obtain a parameter of each pixel of the composited surface.

In a possible implementation, the parameter of the pixel of the surface includes but is not limited to: RGB values.

According to a second aspect, an embodiment of this application provides a terminal device, including one or more functional units configured to perform the method according to the first aspect or any implementation of the first aspect. The functional unit may be implemented by using a software module, or may be implemented by using hardware such as a processor, or may be implemented by combining software and necessary hardware.

According to a third aspect, an embodiment of this application provides a terminal device, including a memory, a processor, and a computer program stored in the memory. When executing the computer program, the processor implements steps of the method according to the first aspect or any implementation of the first aspect.

According to a fourth aspect, an embodiment of this application provides a computer readable storage medium. The computer readable storage medium stores a computer program (instructions). When the program (instructions) is executed by a processor, steps of the method according to the first aspect or any implementation of the first aspect are implemented.

According to the foregoing technical solutions in this application, a control-level TUI is provided, so that the non-secure control in the user interface is compatible with the TUI secure control for display, and at the same time when the secure input interface is displayed, the common interface control can also be displayed, thereby improving user experience.

### BRIEF DESCRIPTION OF DRAWINGS

To describe the technical solutions in the embodiments of this application more clearly, the following briefly describes the accompanying drawings required for describing the embodiments of this application.

FIG. 1 is a schematic diagram of performing a transfer operation by using a trusted user interface (TUI);

FIG. 2 is a schematic diagram of a terminal device according to an embodiment of this application;

FIG. 3 is a schematic diagram of a control according to an embodiment of this application;

FIG. 4 is a tree structure of a control in a user interface according to an embodiment of this application;

FIG. 5 is a flowchart of a user interface display method according to an embodiment of this application;

FIG. 6 is a schematic structural diagram of a terminal device according to an embodiment of this application;

FIG. 7 is a schematic structural diagram of another terminal device according to an embodiment of this application;

FIG. 8 is an operating principle diagram of a surface combiner in a TEE according to an embodiment of this application;

FIG. 9 is a schematic structural diagram of another terminal device according to an embodiment of this application; and

FIG. 10 is a schematic structural diagram of another terminal device according to an embodiment of this application.

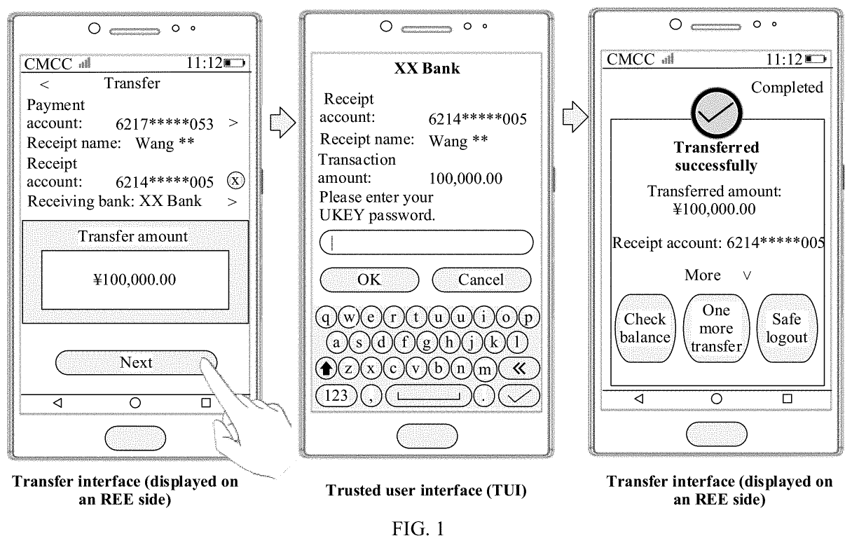

### DESCRIPTION OF EMBODIMENTS

The following describes in detail the technical solutions in the embodiments of this application with reference to the accompanying drawings in the embodiments of this application. Apparently, the described embodiments are merely some rather than all of the embodiments of this application.

An embodiment of this application provides a user interface display method, to implement compatible display of a trusted user interface (TUI) and a user interface of a client application (CA). The method may be applied to a terminal device.

The term “user interface” in the specification, claims, and accompanying drawings of this application, briefly referred to as an interface, is a graphical interface for interaction and information exchange between a user and an application or an operating system. The user interface may be a window, a dialog box, a display area, or the like. A user interface of an application is source code written by using a specific computer language such as Java or extensible markup language (XML). The interface source code is parsed and rendered on a terminal device, and finally is presented as content that can be identified by a user, such as a picture, a text, or a button. A view is a visual component of the user interface. The view is also referred to as a control or a widget. A typical view includes a button, a text field, a progress bar, a keyboard, a picture, a text, and the like. An attribute and content of a control in an interface are defined by using a tag or node. For example, the XML defines a control in the interface by using a node such as <Textview>, <ImgView>, or <ButtonView>. A node corresponds to a control or an attribute in the interface. After being parsed and rendered, the node is presented as content visible to a user.

The terminal device according to the embodiments and claims of this application is a device that provides a user with voice and/or data connectivity, including a wireless terminal or a wired terminal. The wireless terminal may communicate with one or more core networks through a radio access network (RAN). The wireless terminal may be a mobile terminal, such as a mobile phone (or referred to as a “cellular” phone), or a computer having a mobile terminal, for example, may be a portable, pocket-sized, handheld, computer built-in, or vehicle-mounted mobile apparatus. An interface, also referred to as an application programming interface (API), is an encapsulation and an abstract representation of a specific function implemented by computer program code. An application may implement the specific function by invoking the interface. A service is an application component that can be executed in a background without providing a user interface. The service can be started by another application or application component.

The following describes, with more details, the terminal device in this application with reference to the accompanying drawings. It should be noted that postpositive terms “unit” and “module” are merely for ease of description, and these postpositive terms do not have a meaning or function that is distinguished from each other.

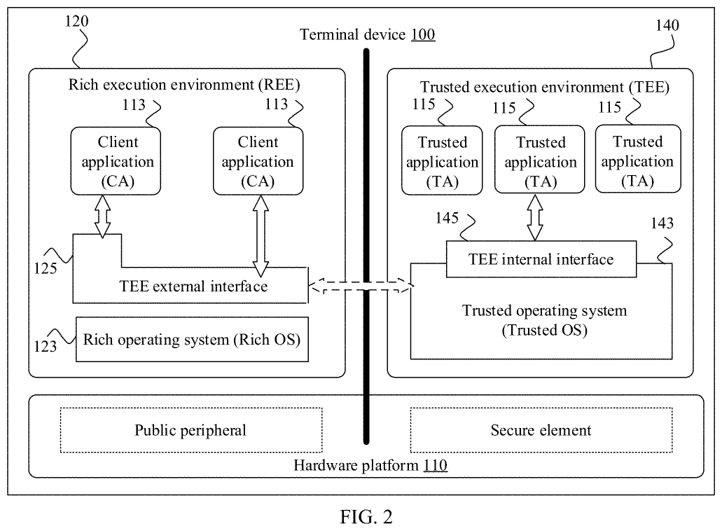

FIG. 2 is an architectural diagram of a terminal device 100 according to an embodiment of this application. As shown in FIG. 2, the terminal device 100 includes a hardware platform 110, and two isolated operating environments running on the hardware platform 100, namely, a rich execution environment (REE) 120 and a trusted execution environment (TEE) 140. The two operating environments each have an independent hardware resource and operating system. The hardware resource of the REE 120 and the hardware resource of the TEE 140 can be isolated by using hardware isolation technologies, such as an ARM® TrustZone mechanism. In addition, isolation between the operating system of the REE 120 and the operating system of the TEE 140 and isolation between applications are implemented by using a virtualization technology. In this way, software and hardware resources that can be accessed by the TEE 140 are separated from those that can be accessed by the REE 120, and the TEE 140 severely restricts data and a function that can be accessed by an application, so that a security level of the TEE 140 satisfies a specific security requirement. Therefore, the TEE 140 is generally considered as a secure execution environment. The REE 120 is an operating environment outside the TEE 140. Compared with the TEE 140, the REE 120 has lower security and is an environment susceptible to attacks. An application running in the REE 120, namely, a client application (CA), is also considered as untrusted.

The hardware platform 110 of the terminal device 100 includes a public peripheral and a trusted peripheral. The trusted peripheral includes a secure element (SE) that can be controlled and accessed only by the TEE 140, such as a secure memory, a secure clock, or a trusted keyboard. The public peripheral is a device that can be controlled and accessed by a rich operating system (Rich OS) 123 in the REE 120.

An application 115 running in the TEE 140 is a trusted application (TA). The TA 115 may provide a security-related function or service for a client application (CA) 113 in the REE 120 or another TA in the TEE 140. A trusted operating system (Trusted OS) 143 running in the TEE 140 provides a TEE internal interface 145 for the TA 115. The TA 115 obtains access permission for a security resource and service by using the TEE internal interface 145. The security resource and service include but are not limited to: key injection and management, encryption, secure storage, a secure clock, a trusted user interface (TUI), and a trusted keyboard.

The rich operating system 123 provides richer features than the trusted operating system 143. The rich operating system 123 is very open and can accept various types of applications, but security of the rich operating system 123 is also lower than that of the trusted operating system 143. The rich operating system 123 may be a terminal operating system such as Android® or iOS®. The CA 113 running in the REE 120 may request, by using an external interface 125 provided by the TEE, a security service provided by the TA 115 in the TEE 140. For example, in a scenario such as mobile payment or an online bank transfer, if sensitive information of a user needs to be input and displayed, an application in the REE 120 may invoke a TUI and a trusted keyboard service on the TEE 140 side by using the external interface 125 provided by the TEE, to prevent the application on the REE side from maliciously intercepting and stealing the sensitive information of the user.

For definitions of terms such as REE, TEE, CA, TA, rich OS, and trusted OS in all embodiments of this application, refer to a TEE related standard proposed by the GlobalPlatform® (GP). It should be understood that in addition to the terminal device with the TEE, the user interface display method provided in the embodiments of this application may also be applied to another type of device, for example, a terminal device or a computer system with a dual domain system (a security domain and a non-security domain).

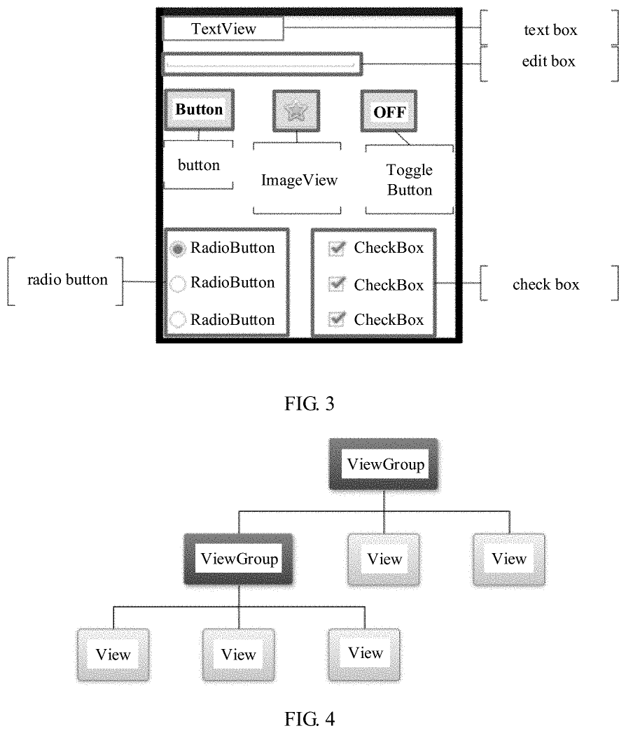

Based on the terminal device 100 described in FIG. 2, an embodiment of this application provides a method for displaying a user interface on the terminal device 100. The user interface is displayed through cooperation between the rich operating system 123 and the trusted operating system 143. The rich operating system 123 provides rich native controls (also referred to as “common control” or “non-secure control” in the embodiments of this application) for an application developer to develop the user interface. Using an Android® system as an example, as shown in FIG. 3, the Android® provides a plurality of native control types, such as a button, a text field (EditText), a radio button (RadioButton), a check box (CheckBox), and a toggle button (ToggleButton). Controls derived from these native control types are common controls (non-secure controls). The application developer can construct the user interface by using a visual development tool or XML code. For example, the application developer may declare in a layout file that one or more of these controls are used, and set an attribute of the control, such as a width, a height, or an ID of the control. The following is an example of an XML layout file that includes the text field and the button:

```
<?xml version=“1.0” encoding=“utf-8”?>
  <LinearLayout xmlns:android=“http://schemas.android.com/apk/res/android”
    android:layout_width=“fill_parent”
    android:layout_height=“fill_parent”
    android:orientation=“horizontal”>
    <EditText android:id=“@+id/edit_message”
      android:layout_weight=“1”
      android:layout_width=“0dp”
      android:layout_height=“wrap_content”
      android:hint=“@string/edit_message” />
    <Button android:id=“@+id/button_send”
      android:layout_width=“wrap_content”
      android:layout_height=“wrap_content”
      android:text=“@string/button_send”
      android:onClick=“sendMessage” />
  </LinearLayout>
```

Based on the native control provided by the rich operating system 123, a customized secure control is further added in this embodiment of this application, and is used for TUI development. The customized secure control satisfies interface security specifications of the TEE 140, and supports configuration of some customized attributes. In addition, a processing method or function corresponding to the customized control, for example, a method such as measurement, layout, or drawing, needs to be rewritten. The developer can create and edit an instance of the customized secure control in an .xml file. In an embodiment, secure controls shown in the following table may be customized:

| | Control type | Control name | Control Function |
|---|---|---|---|
| Native control | Text | TextView | Responsible for |
| | | | displaying a text, not |
| | | | editing the text |
| | | EditText | A control that may |
| | | | edit the text |
| | Button | Button | Button |
| | | ImageViewButton | Picture button |
| | | RadioButton | Radio button |
| | | CheckBox | Check box |
| | Progress | ProgressBar | Display progress |
| | Bar | | information |
| Secure control | Text | Sec-TextView | Secure display field |
| (new) | | Sec-EditText | Secure input field |
| | Button | Sec-Button | Secure button |
| | | Sec-Image | Secure picture |
| | | ViewButton | button |

When developing a user interface of an application, the application developer may use the native control provided by the rich operating system 123, or may use the customized secure control. In this way, a hybrid user interface that includes both the common control and the customized secure control can be developed, reducing development difficulty.

Further, when the client application 113 runs in the REE 120, the rich operating system 123 determines the control included in the user interface and an attribute of the control by parsing source code and/or a layout file corresponding to the user interface. The attribute of the control includes but is not limited to a control type, a control identifier, a control width, a control height, and the like. The control included in the user interface is usually organized in a tree structure. To be specific, controls have a parent-child relationship with each other. Using Android as an example, controls in Android are classified into two types: a ViewGroup control and a view control. As a parent control, the ViewGroup may include a plurality of view controls and manage the controls included in the ViewGroup. As shown in FIG. 4, controls included in an entire user interface logically form a control tree. An upper-layer control is responsible for rendering processing of a lower-layer control and transferring an interaction event. On the top of each control tree, there is a ViewParent object, namely, a core of the control tree. All interaction management events are scheduled by the ViewParent in a centralized manner.

Further, an embodiment of this application further provides a method for compatible display of a user interface that includes a common control and a customized secure control, including the following steps:

Step 510: A rich operating system 123 renders a common control in a user interface, to obtain a first surface.

Step 530: The rich operating system 123 transfers information about a secure control in the user interface to a trusted operating system 143, and the trusted operating system 143 renders the secure control to obtain a second surface.

Step 550: The trusted operating system 143 composites the first surface and the second surface to obtain a composited surface, where the composited surface includes the common control and the secure control. It should be understood that the composited surface that includes the common control and the secure control herein is a graphical representation or a graphical interface that includes both the common control and the secure control.

Step 570: The trusted operating system 143 displays the composited surface on a display of the terminal device 100.

In an embodiment, when using the secure control, a developer needs to configure information related to the secure control in an .xml file, such as a control size, and configure a communication ID in a source file or an installation package of the client application 113. The communication ID corresponds to a trusted application 115 in a TEE. The information about the secure control may be transferred to a corresponding trusted application 115 in the TEE based on the communication ID and by using an external interface provided by the TEE. The trusted application 115 further completes rendering and displaying of the secure control based on a related graphics service or component provided by the trusted operating system 143.

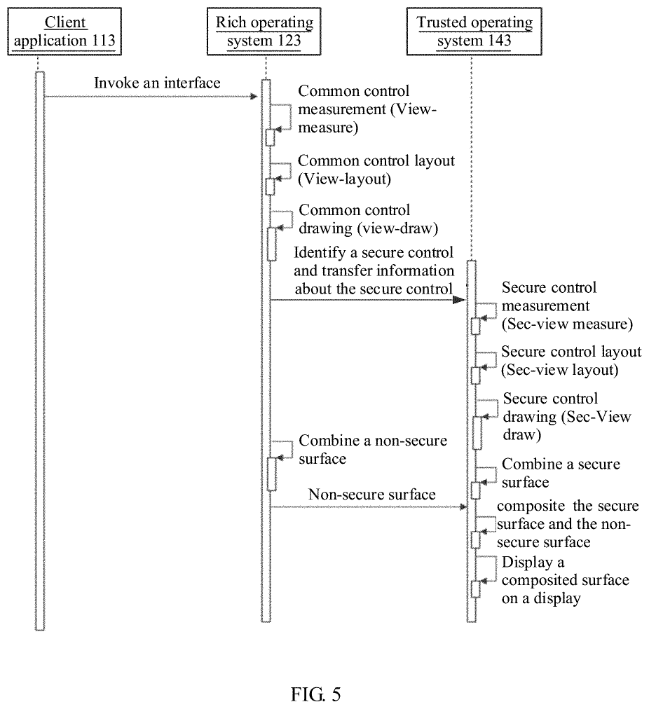

In an embodiment, in step 510, the rich operating system 123 performs rendering processing on a control by invoking a method corresponding to the common control. The method corresponding to the common control is provided by the rich operating system 123 by using a native API. In an embodiment, as shown in FIG. 5, the method corresponding to the control includes: measurement, layout, and drawing operations. The measurement operation is mainly used to calculate a size of the control, namely, a width and a length of the control. Calculation is based on an attribute, such as a width and a height, that is of the control and that is configured in a layout file. The layout operation is used to set a display position of the control on a display. For example, in an embodiment, a position of a control relative to a parent control of the control may be calculated by using the layout operation, for example, a distance from the top, bottom, left and right edges of the control to a vertex in an upper left corner or an upper right corner of the parent control, or a distance from the top, bottom, left and right edges of the control to the top, bottom, left, and right edges of the parent control. The drawing operation is used to draw the control onto the frame buffer to obtain the first surface. Calculation results of the measurement and layout operations may be recorded in a form of parameters. The drawing operation may be used to draw the control based on these parameters. A specific graphics library such as OpenGL may be invoked during a drawing process.

In an embodiment, a security label is added to the secure control to identify the secure control. The client application and the rich operating system can identify, based on the security label, the secure control from the control included in the user interface. The security label may be a control name, a control ID, signature information, or the like.

In an embodiment, in step 530, a communications agent in the rich operating system 123 may transfer information about a customized secure control in the user interface to the trusted operating system 143 by using a TEE external interface 125. An attribute of the customized secure control is configured by the developer by using a layout file or code. Methods (measurement, layout, and drawing) corresponding to the customized control are rewritten, that is, are defined by the developer, to satisfy a requirement for display on the TEE side. The information about the secure control transferred by the rich operating system 123 includes an attribute of the secure control, such as a width or a height. The trusted operating system 143 performs measurement, layout and drawing processing on the secure control by invoking the method corresponding to the secure control, to obtain the second surface.

In an embodiment, the first surface (non-secure surface) obtained in step 510 is in a frame buffer of the rich operating system 123. The second surface (secure surface) obtained in step 530 is in a frame buffer of the trusted operating system 143. The trusted operating system 143 may access the frame buffer of the rich operating system 123. However, the frame buffer of the trusted operating system 143 cannot be accessed by the rich operating system 123. The rich operating system 123 and the trusted operating system 143 each may have a plurality of frame buffers. If a plurality of surfaces are obtained after a control is rendered, the plurality of surfaces may be separately in different frame buffers.

In an embodiment, when the rich operating system 123 renders the common control, a plurality of surfaces may be generated, where each surface is in a separate frame buffer. The rich operating system 123 may invoke graphics-related hardware to first offline combine the plurality of surfaces into the first surface.

In an embodiment, the trusted operating system 143 composites the first surface and the second surface into a composited surface. The composited surface includes both the common control and the secure control. With assistance of a display driver, the composited surface is displayed by using a display. The composited surface that includes the common control and the secure control herein is a graphical representation or a graphical interface that includes both the common control and the secure control.

In an embodiment, in step 550, the rich operating system 123 may send the first surface (non-secure surface) to the trusted operating system 143 by using the communications agent. The trusted operating system 143 further composites the first surface and the second surface, to obtain the composited surface. The rich operating system 123 may also transfer, to the trusted operating system 143 by using the communications agent, the address of the frame buffer in which the first surface is located. The trusted operating system 143 may access the first surface in the frame buffer of the rich operating system 123 based on the address, to complete surface composition.

In an embodiment, in step 550, the trusted operating system 143 may composite a first surface A and a second surface B by using an AlphaBlend algorithm, to generate a composited surface C. RGB values of each pixel in the composited surface C are calculated based on RGB values of a pixel at a corresponding position of the first surface A and RGB values of a pixel at a corresponding position of the second surface B by using the following formula:

R(C)=(1−alpha)*R(B)+alpha*R(A)

G(C)=(1−alpha)*G(B)+alpha*G(A)

B(C)=(1−alpha)*B(B)+alpha*B(A)

where alpha is a constant and is used to represent transparency. If alpha is 0, it indicates complete transparency. If alpha is 255, it indicates complete opaqueness.

In an embodiment, when creating a user interface, the client application 113 on the REE side invokes an interface provided by the rich operating system 123, so that the rich operating system 123 performs rendering processing on the common control in the user interface by invoking measurement, layout, and drawing methods based on a layout file of the user interface. A non-secure surface (excluding the secure control) obtained after the rendering processing is buffered in the frame buffer of the rich operating system 123, and is synchronized to the frame buffer of the trusted operating system based on a communication channel between the TEE and the REE. Further, the rich operating system 123 transfers identified information about the secure control in the user interface to the trusted operating system 143. The trusted operating system 143 performs rendering processing on the secure control based on the information about the secure control and a customized method (measure, layout, or draw) corresponding to the secure control. A secure surface (including only the secure control) obtained after the rendering processing is buffered in the frame buffer of the trusted operating system 143. Finally, the trusted operating system 143 composites the secure surface and the non-secure surface, and then displays the composited surface by using a display.

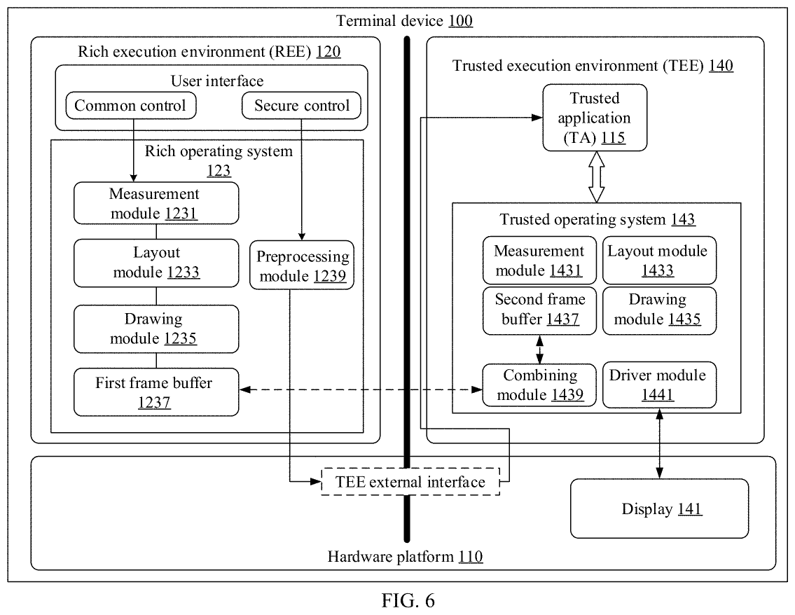

FIG. 6 shows a more specific example in which the rich operating system 123 and the trusted operating system 143 cooperate with each other to process the control in the user interface. According to FIG. 6, the rich operating system 123 includes: a measurement module 1231, a layout module 1233, and a drawing module 1235, respectively configured to perform measurement, layout, and drawing operations on the common control in the user interface to obtain a non-secure surface (excluding a secure control). For details about measurement, layout, and drawing of the control, refer to the description in step 510. A non-secure surface obtained after the common control is drawn is in a first frame buffer 1237. The first frame buffer 1237 is buffer space that can be controlled and accessed by the rich operating system 123.

Further, in an embodiment, the client application transfers the information about the secure control in the user interface to the trusted application 115 by invoking the communications agent (not shown in the figure) provided by the rich operating system and/or the external interface provided by the TEE. The trusted application then invokes a graphics service or component of the trusted operating system 143 to complete rendering of the secure control. In an embodiment, the trusted operating system 143 includes: a measurement module 1431, a layout module 1433, a drawing module 1435, a combining module 1439, and a driver module 1441. The measurement module 1431, the layout module 1433, and the drawing module 1435 are respectively configured to perform the measurement, layout, and drawing operations on the secure control in the user interface, to obtain the secure surface (including only the secure control). The measurement module 1431, the layout module 1433, and the drawing module 1435 perform measurement, layout, and drawing on the secure control based on the information about the secure control and the customized method (measure, layout, or draw) corresponding to the secure control. For details about measurement, layout, and drawing of the secure control, refer to the description in step 530. A secure surface obtained after the secure control is drawn is in a second frame buffer 1437. The second frame buffer 1437 is buffer space that can be controlled and accessed only by the trusted operating system 143, but cannot be accessed by the rich operating system 123 and the application in the REE 120. The combining module 1439 composites a non-secure surface in the first frame buffer 1237 and a secure surface in the second frame buffer 1437 to obtain a composited surface that includes the common control and the secure control. The driver module 1441 is configured to display the composited surface obtained by the combining module 1439 on a display 141.

In an embodiment, the rich operating system 123 may send the first surface (non-secure surface) to the trusted operating system 143 by using the communications agent. The combining module 1439 in the trusted operating system 143 then composites the first surface and the second surface to obtain the composited surface, where the composited surface is in the second frame buffer 1437. In another embodiment, alternatively, the rich operating system 123 may transfer, to the trusted operating system 143 by using the communications agent, the address of the frame buffer in which the first surface is located. The combining module 1439 in the trusted operating system 143 may access the first surface in the first frame buffer based on the address, and then implement surface composition, where the composited surface is in the second frame buffer 1437.

Optionally, in an embodiment, the rich operating system 123 further includes: a preprocessing module 1239, configured to preprocess, for example, perform initial measurement, layout, and drawing on, the secure control in the user interface. A preprocessing result is synchronized to the trusted operating system 143. The trusted operating system 143 performs further processing on the secure control based on the preprocessing result.

It should be understood that in a specific implementation of the solution, the rendering processing performed by the rich operating system 123 on the common control and the rendering processing performed by the trusted operating system 143 on the secure control are not completely performed in a serial manner, and may be performed in a cross manner or in a parallel manner. It is understood that the terminal device 100 may include fewer or more components than those shown in FIG. 6. The terminal device shown in FIG. 6 merely includes components more related to a plurality of implementations disclosed in the embodiments of this application.

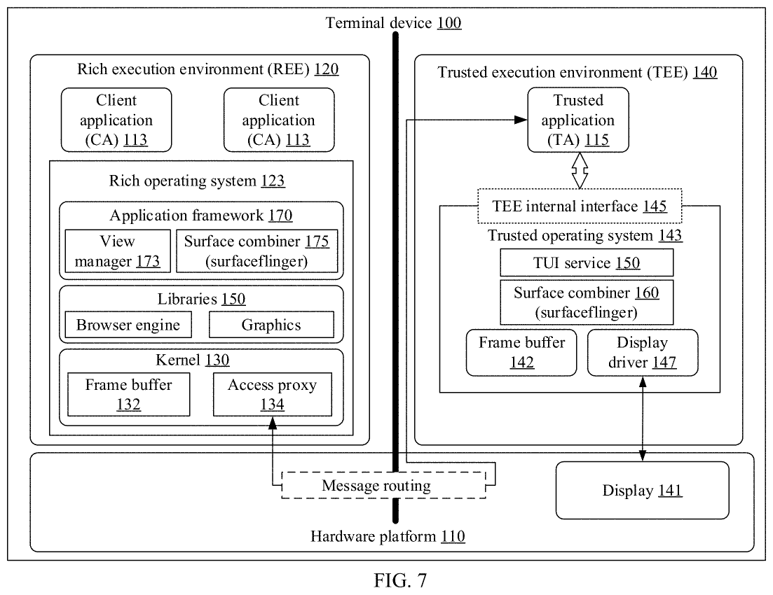

In an embodiment, as shown in FIG. 7, the rich operating system 123 is an Android® system, and may be divided into a kernel 130, libraries 150, and an application framework 170 in terms of architecture. The kernel 130 is used to provide an underlying system component and service, for example, power management, memory management, thread management, a hardware driver program, and an access proxy 134. The access proxy 134 is mainly used to implement communication between the REE 120 and the TEE 140, for example, send or transfer information on the REE 120 side to the TEE 140 by using an interface provided by the TEE. The access proxy 134 is a process or thread in a kernel mode. For example, a function of the access proxy 134 may be undertaken by Tzdriver in the kernel. The library 150 is a program library that provides support for an executable program when the executable program is running, and includes a browser engine (such as webkit), a graphics processing engine (such as OpenGL ES), and the like. The framework 170 is used to provide a basic common component and service for the application, such as window management and view management. In an embodiment, the framework 170 includes a view manager 173, a surface combiner 175, and the like. The view manager 173 is used to perform operations such as measurement, layout, and drawing on a native view control, namely, the common control, in the user interface of the client application 113. The surface combiner 175 is used to combine surfaces drawn into a frame buffer 132, and then send a combined surface to a display device for display. The frame buffer 132 is a storage area that can be accessed by a process or thread in the kernel mode, and is used to buffer the surface drawn by the view manager 173.

In an embodiment, the view manager 173 may specifically implement the measurement, layout, and drawing operations on the native view control respectively by using onMeasure( ), onLayout( ), and onDraw( ) functions provided by the Android® system. The surface combiner 175 provides a SurfaceFlinger service for the Android® system. The view manager 173 draws the control on the surface into the frame buffer 132. The SurfaceFlinger service uses a graphics library to render the surface in the frame buffer to a hardware frame buffer.

In an embodiment, as shown in FIG. 7, the trusted operating system 143 includes a trusted user interface (TUI) service 150, a surface combiner 160, a display driver 147, and a frame buffer 142. After identifying the customized secure control in the user interface of the client application 113, the application framework 170 transfers the information about the customized secure control to the trusted application 115 in the TEE 140 by using the access proxy 134. The trusted application 115 may perform operations such as measurement, layout, and drawing on the customized secure control by invoking a TUI service 150 through a TEE internal interface 145, and then buffer an obtained secure surface to the frame buffer 142. The surface combiner 160 composites the secure surface and the non-secure surface (excluding the secure control) that is in the frame buffer 132 to obtain a composited surface, where the composited surface is in the frame buffer 142. Finally, the composited surface is displayed on the display 141 by using the display driver 147.

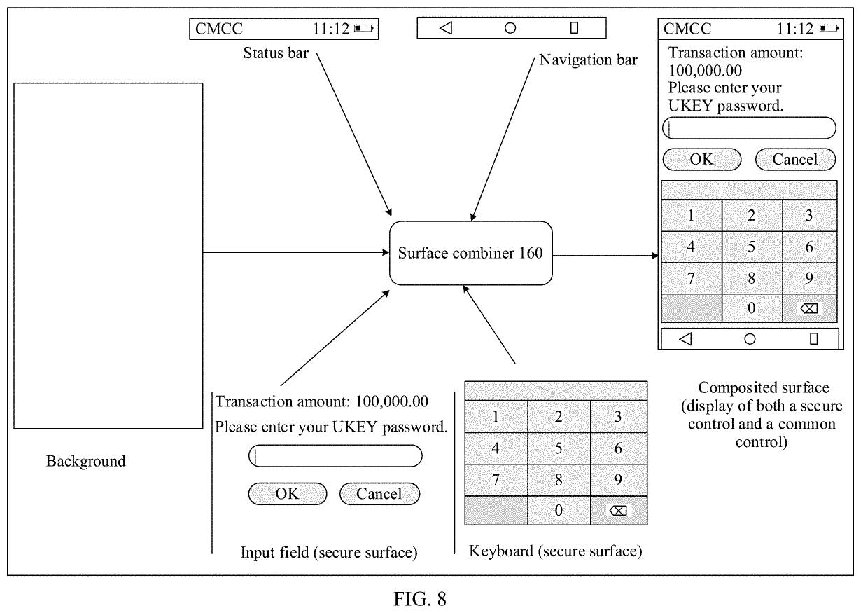

Specifically, in an embodiment, as shown in FIG. 8, the view manager 173 of the rich operating system 123 performs operations such as measurement, layout, and drawing on the native view control to obtain one or more non-secure surfaces, such as a background surface, a status bar surface, and a navigation bar surface. The non-secure surface is buffered in the frame buffer 132. If there are a plurality of non-secure surfaces, the plurality of surfaces may be buffered into a plurality of frame buffers. For example, each non-secure surface is in an independent frame buffer. After performing operations such as measurement, layout, and drawing on the customized secure control, such as a secure input field and a secure keyboard light, the TUI service 150 buffers the obtained secure surface to the frame buffer 142. The surface combiner 160 composites the non-secure surface and the secure surface to obtain the composited surface that includes both the secure control and the native control. The composited surface is finally displayed by using the display 141, thereby implementing compatible display of the secure control and the non-secure control. Optionally, if there are a plurality of non-secure surfaces, before the surface combiner 160 performs composition, the rich operating system 123 may first invoke hardware to offline combine the plurality of non-secure surfaces, to combine the plurality of non-secure surfaces into one surface. Then, the surface combiner 160 composites the combined surface and the secure surface.

In an embodiment, the surface combiner 160 may composite the non-secure surface and the secure surface by using the AlphaBlend algorithm, to generate the composited surface. For specific implementation details of the AlphaBlend algorithm, refer to the foregoing embodiment.

The foregoing functions of the components of the rich operating system 123 and the trusted operating system 143 may be implemented by the processor by executing a program stored in the memory 105.

A person skilled in the art may understand that the terminal device 100 may include fewer or more components than those shown in FIG. 7. The terminal device shown in FIG. 7 merely includes components more related to a plurality of implementations disclosed in the embodiments of this application.

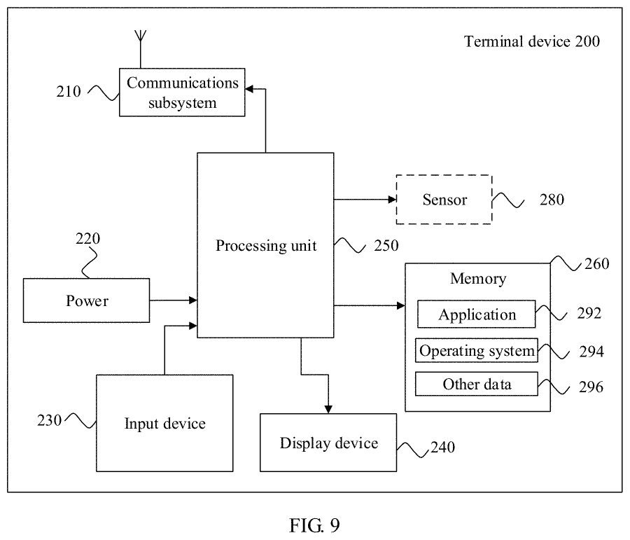

FIG. 9 shows an example of another terminal device 200 according to an embodiment of this application. According to FIG. 9, the terminal device 200 includes a communications subsystem 210, a power supply 220, an input device 230, a display device 240, a processing unit 250, and a memory 260. The memory 260 stores a computer program or instructions. The computer program includes an operating system 294, an application 292, and the like. The processing unit 250 is configured to execute the computer program stored in the memory 260, to implement a method defined by the computer program. For example, the processing unit 250 runs the operating system 294, to implement various functions, on the terminal device 200, of the rich operating system and the trusted operating system described in the foregoing embodiments.

The processing unit 250 may include one or more processors. For example, the processing unit 250 may include an application processor, a graphics processor, a digital signal processor, and the like. When the processing unit 250 includes a plurality of processors, the plurality of processors may be integrated into a same chip, or each may be chips independent of each other.

The memory 260 further stores other data 296 in addition to the computer program. The other data 296 may include data generated during running of the operating system 294 or the application 292, such as system data (for example, a configuration parameter of the operating system 294) and user data.

The memory 260 generally includes an internal memory and an external memory. The internal memory includes but is not limited to a random access memory (RAM), a read-only memory (ROM), a cache, or the like. The external memory includes but is not limited to a flash memory, a hard disk, a universal serial bus (USB) disk, and the like. The computer program is generally stored in the external memory. Before executing the computer program, the processing unit 250 loads the program from the external memory to the internal memory.

In an embodiment, the operating system 294 includes a computer program used to implement the user interface display method provided in the embodiments of this application, for example, a rich operating system and a trusted operating system, so that after running the operating system 294, the processing unit 250 implements steps of the user interface display method according to the embodiments of this application. For example, the view manager 173, the surface combiner 175, the TUI service 150, and the surface combiner 160 described in the foregoing embodiments may be implemented by using a computer program (instructions). After loading and running the computer program (instructions), the processing unit 250 implements respective functions of these modules.

The input device 230 is configured to receive user input information, such as numerical/character information, a touch operation, or a gesture, and generate a corresponding input signal. Specifically, in an embodiment, the input device 230 includes a touch panel. The touch panel, also referred to as a touchscreen, may collect a touch operation of a user on the touch panel, and generate a touch signal to drive a related component to respond to the operation of the user. In addition to the touch panel, the input device 230 may further include another input device, including but not limited to one or more of physical keyboards, a function key (such as a volume control press key or a switch press key), a tracking ball, a mouse, a joystick, or the like.

The display device 240 may be a display panel such as a liquid crystal display (LCD) or an organic light emitting diode (OLED). In some embodiments, the touch panel may cover the display device 240 to form a touch display screen.

The communications subsystem 210 is a basic communications unit of the terminal device 200, and is configured to send and receive data of the terminal device 200. The power supply 220 is configured to supply power to the foregoing components, and may be specifically a power management chip.

When the terminal device 200 is a wireless terminal, the communications subsystem 210 includes a wireless modem, and mainly implements functions such as baseband processing, modulation and demodulation, signal amplification and filtering, and equalization. In an embodiment, the communications subsystem 210 includes: a baseband processor, a radio frequency circuit, and an antenna. The radio frequency circuit and the antenna are mainly responsible for sending and receiving a signal. The baseband processor is responsible for signal processing, such as signal A/D and D/A conversion, and signal encoding and decoding. The baseband processor supports one or more of wireless communications standards. The wireless communications standards herein include but are not limited to global system for mobile communications (GSM), code division multiple access (CDMA), wideband code division multiple access (WCDMA), high speed packet access (HSPA), long term evolution (LTE), and the like. The baseband processor may be an independent chip, or may be integrated with a processor included in the processing unit 250 into a same chip.

Optionally, the terminal device 200 further includes one or more sensors 280, for example, an acceleration sensor and an optical sensor.

The user interface display method provided in the embodiments of this application may be performed by a proper combination of software, hardware, and/or firmware of the terminal device 200. For example, the operating system 294 shown in FIG. 9 may be implemented in combination with necessary hardware.

In addition, a person skilled in the art may understand that the terminal device 200 may include fewer or more components than those shown in FIG. 9. The terminal device 200 shown in FIG. 9 merely shows components more related to a plurality of implementations disclosed in the embodiments of this application.

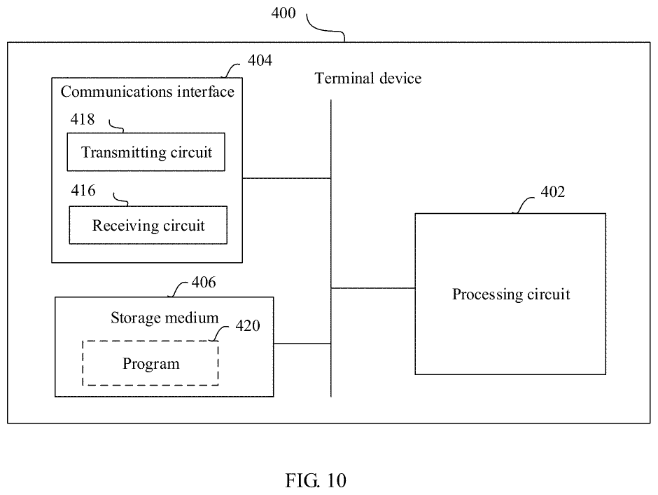

Based on the user interface display method described in the foregoing embodiments, an embodiment of this application further provides a terminal device 400. As shown in FIG. 10, the terminal device 400 includes: a processing circuit 402, and a communications interface 404 and a storage medium 406 that are connected to the processing circuit 402.

The processing circuit 402 is configured to process data, control data access and storage, deliver a command, and control another component to perform an operation. The processing circuit 402 may be implemented as one or more processors, one or more controllers, and/or another structure that may be configured to execute a program. The processing circuit 402 may specifically include at least one of a general purpose processor, a digital signal processor (DSP), an application-specific integrated circuit (ASIC), a field-programmable gate array (FPGA), or another programmable logic component. The general purpose processor may include a microprocessor, and any conventional processor, controller, micro-controller, or state machine. The processing circuit 402 may be implemented as a computing element, for example, a combination of the DSP and the microprocessor.

The storage medium 406 may include a non-transitory computer-readable storage medium, such as a magnetic storage device (for example, a hard disk, a floppy disk, or a magnetic stripe), an optical storage medium (for example, a digital versatile disc (DVD), a smart card, a flash memory device, a RAM, a ROM, and a programmable read-only memory (PROM), an erasable programmable read-only memory (EPROM), a register, and any combination thereof. The storage medium 406 may be coupled to the processing circuit 402, so that the processing circuit 402 can read information and write information into the storage medium 406. Specifically, the storage medium 406 may be integrated into the processing circuit 402, or the storage medium 406 and the processing circuit 402 may be separate.

The communications interface 404 may include a circuit and/or a program to implement mutual communication between the terminal device 400 and one or more network devices (for example, a router, a switch, an access point, and the like). The communications interface 404 includes at least one receiving circuit 416 and/or at least one transmitting circuit 418. In an embodiment, the communications interface 404 may be completely or partially implemented by a wireless modem.

In an embodiment, the storage medium 406 stores a program (instructions) 420. The processing circuit 402 is adapted to execute the program (instructions) 420 stored in the storage medium 406, to implement some or all steps in any method embodiment of this application.

An embodiment of this application further provides a computer readable storage medium. The computer readable storage medium stores code, instructions, or a program that implements steps of the method in any method embodiment of this application.

It may be clearly understood by a person skilled in the art that, for the purpose of convenient and brief description, for a detailed working process of the foregoing described apparatus and unit, reference may be made to a corresponding process in the foregoing method embodiments, and details are not described herein again.

The user interface display method provided in the embodiments of this application may also be applied to a device having a dual domain system. The device includes a non-security domain and a security domain that are isolated from each other. A security level of the security domain is higher than that of the non-security domain. Similar to the TEE and the REE described in the foregoing embodiments, an application running in the non-security domain may also request a service in the security domain by using a specific interface. A graphics service or component in the non-security domain renders a common control included in a user interface of the application, to obtain one or more non-secure surfaces are obtained. A graphics service or component in the security domain renders a customized secure control included in the user interface, to obtain one or more secure surfaces. Finally, after the graphics service or component in the security domain composites, in the security domain, the secure surface and the non-secure surface, a composited surface is displayed by using a display. For specific implementation details about rendering the control in the security domain and the non-security domain and about compositing surfaces, refer to the foregoing method embodiments. Details are not described herein again.

In the several embodiments provided in this application, it should be understood that the disclosed apparatus and method may be implemented in another manner. For example, the described apparatus embodiments are merely examples. For example, division of the unit is merely logical function division. There may be other division in actual implementation. For example, a plurality of units or components may be combined or may be integrated into another system, or some features may be ignored or not performed. In addition, the indicated or discussed mutual couplings or direct couplings or communication connections may be implemented through some interfaces. The indirect couplings or communication connections between the apparatuses or units may be implemented in electronic, mechanical, or other forms.

In addition, functional units in the embodiments of this application may be integrated into one processing unit, or the units may be physically separated, or two or more units may be integrated into one unit.

When the functions are implemented in a form of a software functional unit and sold or used as an independent product, the functions may be stored in a computer readable storage medium. Based on such an understanding, the technical solutions of this application essentially, or the part contributing to the prior art, or some of the technical solutions may be implemented in a form of a computer software product. The computer software product is stored in a storage medium, and includes instructions for instructing a computer device (which may be a personal computer, a server, a network device, or the like) to perform all or some of the steps of the methods described in the embodiments of this application. The foregoing storage medium includes: various media that can store program code, such as a USB flash drive, a removable hard disk, a ROM, a RAM, or a compact disc.

What is claimed is:

1. A method for displaying a user interface on a terminal device, comprising:
rendering, by a rich operating system, a common control in a user interface of a client application (CA) to obtain a first surface, wherein the terminal device comprises a trusted execution environment (TEE) and a rich execution environment (REE), the rich operating system and the CA run in the REE, a trusted operating system runs in the TEE, and the user interface comprises the common control and a secure control;
rendering, by the trusted operating system, the secure control in the user interface to obtain a second surface;
compositing, by the trusted operating system, the first surface and the second surface to obtain a composited surface that comprises the common control and the secure control; and
displaying the composited surface by using a display.

2. The method according to claim 1, wherein the rendering, by the rich operating system, the common control in the user interface comprises:
performing a measurement operation on the common control to determine a size of the common control;
performing a layout operation on the common control to determine a display position of the common control; and
drawing the common control based on the determined size and display position of the common control to obtain the first surface, wherein the first surface is in a frame buffer of the rich operating system.

3. The method according to claim 1, further comprising: transferring, by the rich operating system, information about the secure control to the trusted operating system by invoking a client application programming interface (Client API) provided by the TEE.

4. The method according to claim 3, wherein the rendering, by the trusted operating system, the secure control in the user interface to obtain a second surface comprises:
performing, by the trusted operating system, a measurement and layout operation on the secure control based on the information about the secure control, to determine a size and a display position of the secure control; and
drawing the secure control based on the determined size and display position of the secure control to obtain the second surface, wherein the second surface is in a frame buffer of the trusted operating system.

5. The method according to claim 2, wherein the compositing, by the trusted operating system, the first surface and the second surface to obtain a composited surface that comprises the common control and the secure control comprises:
obtaining, by the trusted operating system, the first surface that is sent by the rich operating system by using a communications agent; and
compositing, by the trusted operating system, the second surface onto the first surface to obtain the composited surface, wherein the composited surface is in the frame buffer of the trusted operating system.

6. The method according to claim 2, wherein the compositing, by the trusted operating system, the first surface and the second surface to obtain a composited surface that comprises the common control and the secure control comprises:
obtaining, by the trusted operating system, an address that is of the frame buffer of the rich operating system and that is sent by the rich operating system by using a communications agent;
accessing, by the trusted operating system, the first surface in the frame buffer of the rich operating system based on the address; and
compositing the first surface and the second surface to obtain the composited surface, wherein the composited surface is in the frame buffer of the trusted operating system.

7. The method according to claim 1, wherein the rich operating system comprises a plurality of frame buffers; and the rendering, by the rich operating system, the common control in the user interface to obtain a first surface comprising:
rendering, by the rich operating system, the common control in the user interface to obtain a plurality of intermediate surfaces, wherein each intermediate surface is separately in an independent frame buffer; and
combining, by the rich operating system, the plurality of intermediate surfaces into the first surface by invoking hardware.

8. The method according to claim 1, further comprising:
parsing, by the rich operating system, source code or a layout file corresponding to the user interface, to determine the common control and the secure control that are comprised in the user interface.

9. The method according to claim 1, wherein the secure control carries a security label, and the rich operating system distinguishes the secure control from the common control based on the security label.

10. A terminal device, comprising a trusted execution environment (TEE) and a rich execution environment (REE) that are isolated from each other, wherein a rich operating system and a client application (CA) run in the REE, a trusted operating system runs in the TEE, and a user interface of the CA comprises a common control and a secure control;
the rich operating system is configured to render the common control in the user interface to obtain a first surface; and
the trusted operating system is configured to: render the secure control in the user interface to obtain a second surface; and composite the first surface and the second surface to obtain a composited surface that comprises the common control and the secure control, and display the composited surface by using a display.

11. The terminal device according to claim 10, wherein the rich operating system is configured to:
perform a measurement operation on the common control to determine a size of the common control;
perform a layout operation on the common control to determine a display position of the common control; and
draw the common control based on the determined size and display position of the common control to obtain the first surface, wherein the first surface is in a frame buffer of the rich operating system.

12. The terminal device according to claim 10, wherein the rich operating system further comprises: a communications agent, configured to transfer information about the secure control to the trusted operating system.

13. The terminal device according to claim 12, wherein the trusted operating system is configured to:
perform a measurement operation on the secure control based on the information about the secure control, to determine a size of the secure control;
perform a layout operation on the secure control to determine a display position of the secure control; and
draw the secure control based on the determined size and display position of the secure control to obtain the second surface, wherein the second surface is in a frame buffer of the trusted operating system.

14. The terminal device according to claim 12, wherein the communications agent is further configured to synchronize the first surface in a frame buffer of the rich operating system to the frame buffer of the trusted operating system; and
the trusted operating system is further configured to: composite the second surface onto the first surface to obtain the composited surface, wherein the composited surface is in the frame buffer of the trusted operating system.

15. The terminal device according to claim 12, wherein the communications agent is further configured to transfer an address of a frame buffer of the rich operating system to the trusted operating system; and the trusted operating system is further configured to: access the first surface in the frame buffer of the rich operating system based on the address, and composite the first surface and the second surface to obtain the composited surface, wherein the composited surface is in the frame buffer of the trusted operating system.

16. The terminal device according to claim 10, wherein the secure control carries a security label, and the rich operating system is further configured to distinguish the secure control from the common control based on the security label.
